(19) United States
(12) Patent Application Publication
(10) Pub. No.: US 2018/0269761 A1
(43) Pub. Date: Sep. 20, 2018

(54) Cage Rotor and Method for the Production Thereof

(71) Applicant: Bayerische Motoren Werke Aktiengesellschaft, Muenchen (DE)

(72) Inventors: Holger ULBRICH, Muenchen (DE); Manfred SIEGLING, Muenchen (DE); Daniel LOOS, Muenchen (DE)

(21) Appl. No.: 15/985,895

(22) Filed: May 22, 2018

Related U.S. Application Data
(63) Continuation of application No. PCT/EP2016/075150, filed on Oct. 20, 2016.

(30) Foreign Application Priority Data
Nov. 23, 2015 (DE) 10 2015 223 058.9

(51) Int. Cl. H02K 17/16; H02K 15/00

(52) U.S. Cl. CPC H02K 17/165; H02K 15/0012

(57) ABSTRACT

A cage rotor for an asynchronous machine is provided. The cage rotor includes a laminated rotor core made of a plurality of stacked rotor laminations, which each have a plurality of rotor lamination grooves distributed in the circumferential direction. The cage rotor also includes short-circuit rings which are provided on both sides of the laminated rotor core and which each have a plurality of short circuit ring grooves distributed in the circumferential direction, and short-circuit bars which are inserted in the rotor lamination grooves, which extend through the short circuit ring grooves and the ends of which project beyond the short circuit rings. The short circuit ring grooves are open radially outwards and the short circuit bars with the short circuit rings are connected to each other at the side of the short circuit grooves which is at least partially open radially outwards. A method for producing such a cage rotor is also provided.

### CROSS REFERENCE TO RELATED APPLICATIONS

This application is a continuation of PCT International Application No. PCT/EP2016/075150, filed Oct. 20, 2016, which claims priority under 35 U.S.C. § 119 from German Patent Application No. 10 2015 223 058.9, filed Nov. 23, 2015, the entire disclosures of which are herein expressly incorporated by reference.

### BACKGROUND AND SUMMARY OF THE INVENTION

The invention relates to a cage rotor for an asynchronous machine, and a method for producing such a cage rotor, where the asynchronous machine is particularly intended for use in motor vehicles.

The rotor of an asynchronous machine (also referred to as a short-circuit rotor or cage rotor) includes a stack of metal laminations (a so-called laminated rotor core) with stamped-in grooves. Through these grooves extend short-circuit bars, which are provided on the end faces of the metal laminations stack with end rings (so-called short-circuit rings). It is of known art to cast the short-circuit bars (e.g., by way of a die casting method), wherein the short-circuit bars are cast into the stamped-in grooves of the metal laminations stack. It is also of known art to insert prefabricated bars into the grooves of the metal laminations stack. At the ends the short-circuit bars are provided with cast-on or pre-fabricated short-circuit rings.

A cage rotor of this type is of known art from DE 10 2009 034 647 A1. In this cage rotor short-circuit bars are slid into grooves of a laminated rotor core. Short-circuit rings are cast onto the short-circuit bar ends projecting from the end faces of the laminated rotor core. The bar ends projecting from the cast-on short-circuit rings can be used as balancing studs.

The balancing concept of a cage rotor constructed in this manner is very advantageous, but voids can occur in cast or partially cast cage rotors in the course of the casting process. These can greatly reduce the mechanical strength locally, so that these cage rotors are used only to a limited extent when requirements are demanding, such as those found in vehicle applications. The requirements could be counteracted by providing expensive supportive measures that reduce the loading on the short-circuit ring. However, such measures are associated with both higher costs and increased production complexity.

An object of the invention is to provide a cage rotor for an asynchronous machine that is cost-effective and offers an advantageous balancing concept. This and other objects are achieved with a cage rotor and/or a method for producing a cage rotor in accordance with embodiments of the invention.

In accordance with an embodiment of the invention, a cage rotor for an asynchronous machine includes a laminated rotor core made up from a plurality of stacked rotor laminations, which each have a plurality of rotor lamination grooves distributed in the circumferential direction, and short-circuit rings, arranged on both sides of the laminated rotor core, which each have a multiplicity of short-circuit ring grooves distributed in the circumferential direction. The cage rotor includes short-circuit bars, which are inserted into the rotor lamination grooves, which extend through the short-circuit ring grooves and whose ends project beyond the short-circuit rings. The short-circuit ring grooves are at least partially open radially outwards, and the short-circuit bars are connected to, or are attached to, the short-circuit rings on the side of the short-circuit grooves that is open radially outwards, in particular they are connected to each other such that they cannot be released without damage. Here, the short-circuit ring grooves are preferably fully open radially outwards, i.e., the short-circuit ring grooves are open over their entire length in the axial direction of the cage rotor (over the entire thickness of the respective ring). However, it is also possible for the short-circuit ring grooves to be only partially open radially outwards, i.e., the short-circuit ring grooves are open over a certain section in the axial direction of the cage rotor (the thickness of the respective ring). In this embodiment, the balancing of the cage rotor (the rotor) can take place in accordance with the invention by way of the short-circuit bar ends projecting beyond the short-circuit ring. This preferably occurs by the removal of material at the bar ends. Alternatively, a fitting of balancing weights would also be possible. Furthermore, the connection technology of short-circuit bars and short-circuit rings can be used to achieve cost-effective manufacture in series production, the cage rotor of which enables high loading requirements to be set. Thus, this embodiment combines the advantages of a simple and cost-effective balancing concept of cage rotors with the properties of a cage rotor also to withstand high loads and to provide sufficient strength in the vehicle sector. In particular, the manner of construction described has the advantage, in contrast to balancing concepts that remove material from the short-circuit ring itself, that this manner of construction affects neither the strength of the short-circuit ring nor the electromagnetic properties negatively, since the cross-sectional area of the short-circuit ring is not altered. The high number of short-circuit bars results in a high degree of flexibility with regard to possible balancing positions.

In accordance with a further embodiment of the invention, the short-circuit bars are welded or brazed together with the short-circuit rings on the side of the short-circuit ring grooves that is open radially outwards. This type of connection ensures electrical conductivity with high strength.

In accordance with a further embodiment of the invention, the short-circuit ring grooves have a section in which the short-circuit ring grooves taper radially outwards. As a result of the outwards taper, the short-circuit bars, which in operation are subject to a radially outwards force as a result of the centrifugal force, are held in the short-circuit ring grooves, which leads to an offloading of the connection between the short-circuit cage and the short-circuit bar.

In accordance with a further embodiment of the invention, the short-circuit rings are in each case constructed from at least two rings stacked together. As two rings are arranged side-by-side, the edges of the rings that are facing radially outwards and facing each other can be chamfered cost-effectively. The resulting groove, running in an encircling manner along the circumference of the short-circuit ring, serves to enable the application of the welded seam, with which not only are the rings connected to one another, but in particular, the short-circuit bars are also welded to the short-circuit rings. If this groove were missing, then the short-circuit bar and short-circuit ring would have to close flush together as accurately as possible in the radially outwards direction in order to achieve a good welded/brazed joint. With such a groove a sufficient contact surface area is present for the welded/brazed joint.

In accordance with a further embodiment of the invention, the short-circuit rings are forged, stamped out, chamfered, or cut out to their shape.

In accordance with a further embodiment of the invention, a continuous or interrupted welded seam or brazed joint running in an encircling manner in the circumferential direction of the short-circuit rings runs on the side of the short-circuit rings facing radially outwards, in each case between two adjacent rings, by way of which welded seam or brazed joint the short-circuit bars are also connected to the short-circuit rings. By way of this, the advantages already mentioned above in the context of the two rings stacked together are achieved.

In accordance with a further embodiment of the invention, the short-circuit rings and/or short-circuit bars include aluminum. This enables a lighter structure for the cage rotor.

In addition, the invention also provides a method for producing a cage rotor with the following acts: providing a laminated rotor core from a plurality of stacked rotor laminations, which in each case have a plurality of circumferentially distributed rotor lamination grooves; inserting short-circuit bars into the rotor lamination grooves, such that the short-circuit bars project from both end faces of the laminated rotor core; attaching short-circuit rings onto both end faces of the laminated rotor core, such that the short-circuit bars are inserted into the short-circuit ring grooves and, in the fully attached state of the short-circuit rings, the short-circuit bars project beyond the short-circuit rings; and connecting the short-circuit bars with the short-circuit rings on a side of the short-circuit ring grooves that is at least partially open radially outwards. This method achieves the advantages already described above in the context of the cage rotor.

In accordance with a development of the method, the short-circuit bars are connected with the short-circuit rings, whereby the short-circuit bars are welded or brazed together with the short-circuit rings on the side of the short-circuit ring grooves that is open radially outwards.

In accordance with a development of the method, the short-circuit bars are connected with the short-circuit rings, whereby the short-circuit bars are connected with the short-circuit rings on the side of the short-circuit ring grooves that is open radially outwards by way of a continuous or interrupted welded seam or brazed joint running in an encircling manner in the circumferential direction of the short-circuit rings.

In accordance with a development of the method, the short-circuit rings are in each case constructed from at least two rings stacked together, with the act of the welding or brazing of two adjacent rings, in each case on the side of the short-circuit rings facing radially outwards, by way of a continuous or interrupted welded seam or brazed joint running in an encircling manner in the circumferential direction of the short-circuit rings, with which the short-circuit bars are also connected to the short-circuit rings.

In accordance with a development, the method furthermore has the act of balancing the cage rotor by the removal of material from selected short-circuit bars projecting beyond the short-circuit rings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic view of main components of a cage rotor, namely on the left a short-circuit cage, and on the right a laminated rotor core.

FIG. 2 is a view of the main components from FIG. 1 in an assembled state.

FIG. 3 is a sectional view of a rotor lamination from the laminated rotor core.

FIG. 4 is a side view of a mounted cage rotor.

FIG. 5 is a plan view of one end of an assembled cage rotor.

FIG. 6 is a plan view of a fully mounted cage rotor.

FIG. 7 is a three-dimensional view of an assembled cage rotor.

### DETAILED DESCRIPTION OF THE DRAWINGS

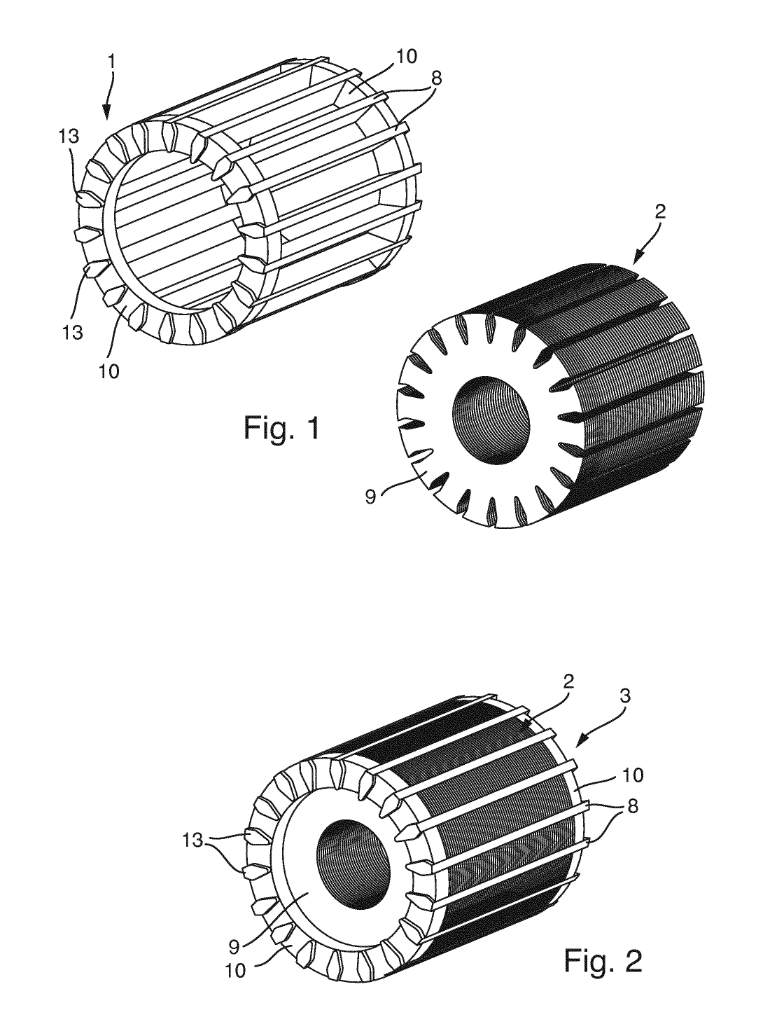

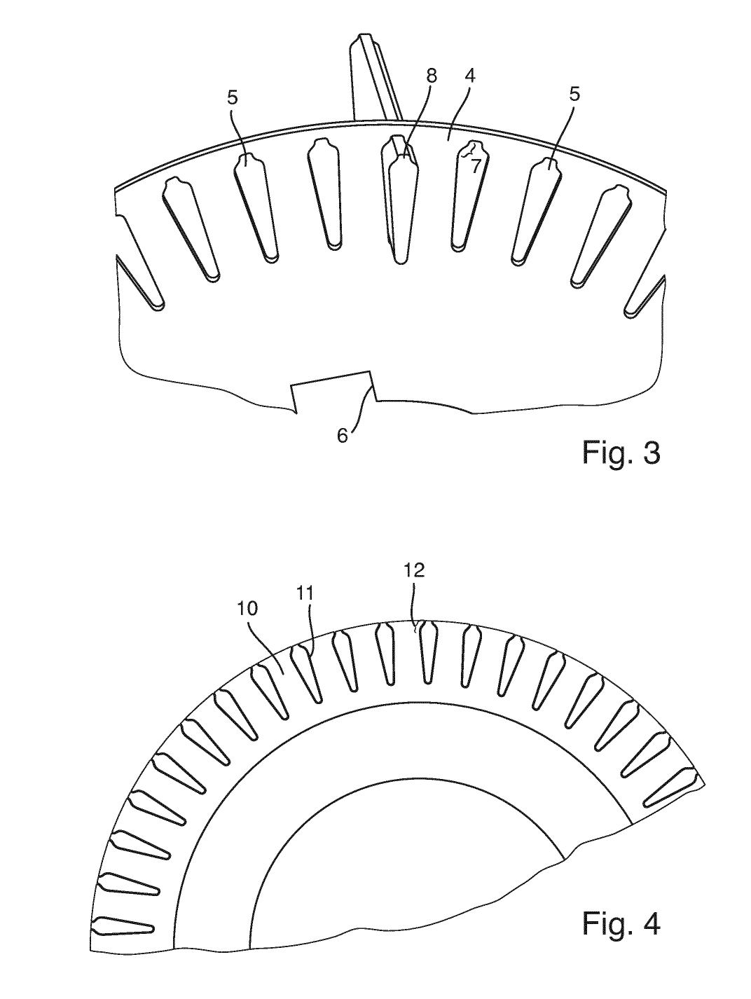

FIG. 1 shows schematically the main components of a cage rotor, wherein on the left is illustrated a short-circuit cage 1, and on the right a laminated rotor core 2. FIG. 2 shows these main components in an assembled state, in which the laminated rotor core 2 is arranged in the short-circuit cage 1, and thus a cage rotor 3 is formed.

The structure of the laminated rotor core 2 will be explained in more detail with reference to FIG. 3. FIG. 3 shows a section of a rotor lamination 4 with rotor lamination grooves 5 introduced therein. Each of the rotor laminations 4 has a circular outer periphery and a circular inner periphery, which is provided with a shaft groove 6, which engages with a shaft journal (not shown). The individual rotor laminations 4 are insulated from one another, and consist essentially of iron or an iron alloy. The rotor lamination grooves 5 preferably have identical shapes, and are distributed at regular intervals from one another along a circumferential direction of the rotor lamination 4. Starting from a radially inner end of the rotor lamination grooves 5, the rotor lamination grooves 5 widen at right angles to the radial direction (and within the rotor lamination plane). The radially outer end of the rotor lamination grooves 5 is either open, as shown in FIG. 1, or closed, as shown in FIG. 3. In the former case, only the radially outer ends of the rotor lamination grooves 5 are open. In both variants a section 7 can be provided at the radially outer end of the rotor lamination grooves 5, in which the rotor lamination grooves 5 taper radially outwards at right angles to the radial direction. However, it is not essential for this tapering section 7 to be present. A plurality of such rotor laminations 4 are stacked concentrically together, wherein the adjacent rotor sheets 4 are in contact with one another so as to form a laminated rotor core 2.

Short-circuit bars 8 are slid through the mutually aligned rotor lamination grooves 5 of the individual rotor laminations 4. Here the cross-sectional shape of the short-circuit bars 8 corresponds to the shape of the rotor lamination grooves 5. The short-circuit bars 8 are made, for example, from aluminum, copper, an alloy comprising aluminum and/or copper, or another electrically conductive metal. In addition, the short-circuit bars 8 can be made from both aluminum and copper, for example, the interior of the short-circuit bars 8 can be made from aluminum that is surrounded by a copper layer. This has the advantage that where the highest currents flow, namely in the outer region of the short-circuit bars 8, they are made from the high conductivity copper, while the interior is made of the lighter aluminum.

The short-circuit bars 8 are inserted into the rotor lamination grooves 5 of the laminated rotor core 2 such that they project from the end faces 9 of the laminated rotor core 2. Short-circuit rings 10 are attached onto the short-circuit bar ends projecting at both ends from the laminated rotor core 2. The short-circuit rings 10 will be described in more detail with reference to FIG. 4. FIG. 4 shows a side view of a mounted cage rotor 3. The short-circuit rings 10 also have a plurality of circumferentially distributed short-circuit ring grooves 11. The short-circuit ring grooves 11 have a shape corresponding to the cross-section of the short-circuit bars 8. Starting from a radially inner end of the rotor lamination grooves 11, the rotor lamination grooves 11 widen at right angles to the radial direction. The radial outer ends of the short-circuit ring grooves 11 are at least partially open in order to perform the welding process that is explained later. A section 12 can be provided at the radially outer end of the short-circuit ring grooves 11, in which the short-circuit ring grooves 11 taper radially outwards at right angles to the radial direction (and within the short-circuit ring plane). However, it is not essential for this tapered section 12 to be present. The short-circuit ring grooves 11 can also be partially closed on the side facing radially outwards (i.e., in some sections in the axial direction).

Here the length of the short-circuit bars 8 is dimensioned such that in the fully mounted state of the cage rotor 3, the short-circuit bars 8 project from the short-circuit rings 10 at both ends. Here, the length of the short-circuit bars 8 that is projecting is the same for all short-circuit bars 8. These projecting ends form balancing studs 13, which can best be seen in FIG. 1 and FIG. 2.

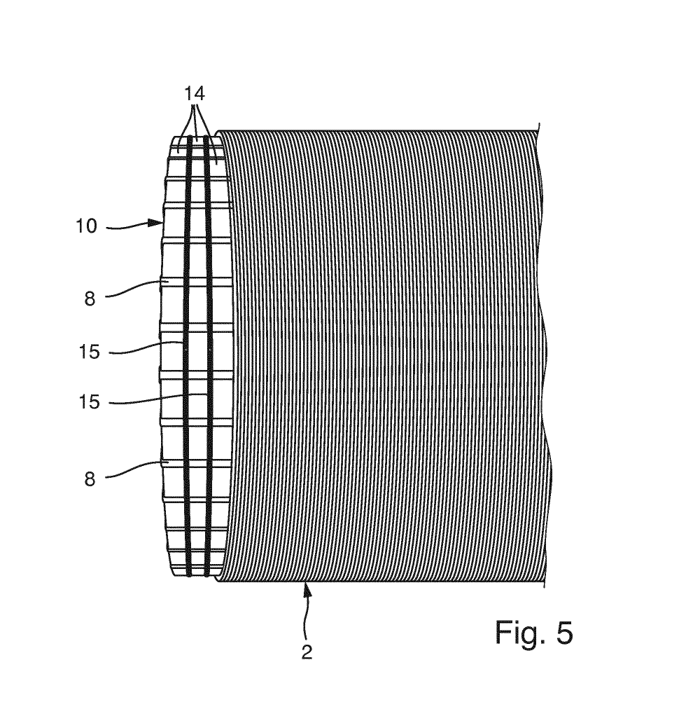

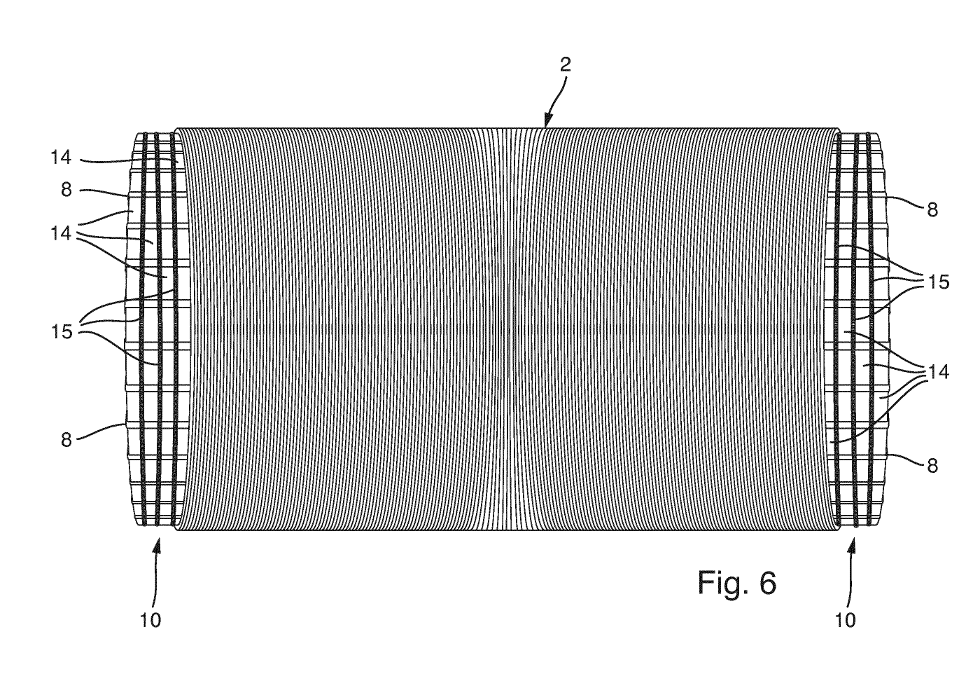

FIG. 5 shows a plan view of one end of a fully mounted cage rotor 3. As can be seen in FIG. 5, the short-circuit rings 10 are constructed from a plurality of rings 14 arranged side-by-side. In FIG. 5, the short-circuit rings 10 include three rings 14 in each case. The individual rings 14 have the same outer contour, inner contour and congruent short-circuit ring grooves 11. The short-circuit ring grooves 11 are preferably fully open radially outwards, i.e., the short-circuit ring grooves are open over their entire length in the axial direction (of the cage rotor), i.e., over the entire thickness of the respective ring 14. However, it is also possible for the short-circuit ring grooves 11 to be only partially open radially outwards, i.e., the short-circuit ring grooves 11 are open over a certain section in the axial direction (of the cage rotor), i.e., the thickness of the respective ring 14, for example as a result of one-sided or two-sided chamfering of the rings 14.

In FIG. 5, the stacked rotor laminations 4 can be seen inside the short-circuit ring 10. Upon entry into the laminated rotor core 2, the short-circuit bars 8 can no longer be seen in FIG. 5, because they are then covered by the closed outer ends of the rotor lamination grooves 5, as shown in FIG. 3. To connect the short-circuit bars 8 with the short-circuit rings 10, more precisely with the individual rings 14, welded seams 15 running in an encircling manner in the circumferential direction of the short-circuit rings 10 are provided. By way of the welded seams 15, respectively adjacent rings 14 are on the one hand connected to one another, and at the same time the rings 14 and thus the entire short-circuit ring 10, are connected to the short-circuit bars 8. As an alternative to the connection technology of welding, another connection technology such as brazing can be used. Advantageously, this takes the form of a connection technology, which on the one hand ensures sufficient robustness, and on the other hand ensures the required electrical conductivity. The welded seam 15 or brazed joint, as mentioned, preferably extends closed in the circumferential direction along the side of the rings 14 facing radially outwards, but it can also be embodied in an interrupted or punctiform manner. In a punctiform embodiment, the connection points are to be provided in particular at the point of transition from the material of the short-circuit bars 8 to that of the rings 14, i.e., in the region of the radially outer open side of the short-circuit ring grooves 11. In that two rings 14 are arranged side-by-side, the edges of the rings 14 that are facing radially outwards and facing each other can be chamfered. The resulting groove (covered by the welded seam 15), running in an encircling manner along the circumference of the short-circuit ring, serves to enable the application of the welded seam 15. With such a groove, a sufficient contact surface area exists for the welded/brazed joint. However, the short-circuit rings 10 need not necessarily be constructed from a plurality of rings 14, as described above, but can also be embodied in one piece. The rings 14 and the short-circuit ring 10 are preferably made from aluminum or copper. The rings 14 and/or the short-circuit ring 10 are/is preferably stamped, forged, milled, or cut with a water jet, etc.

FIG. 6 shows a plan view of a fully mounted short-circuit cage rotor 3. In contrast to the cage rotor 3 in FIG. 5, the short-circuit rings 10 each include four rings 14. Apart from this difference, reference is made to the above description.

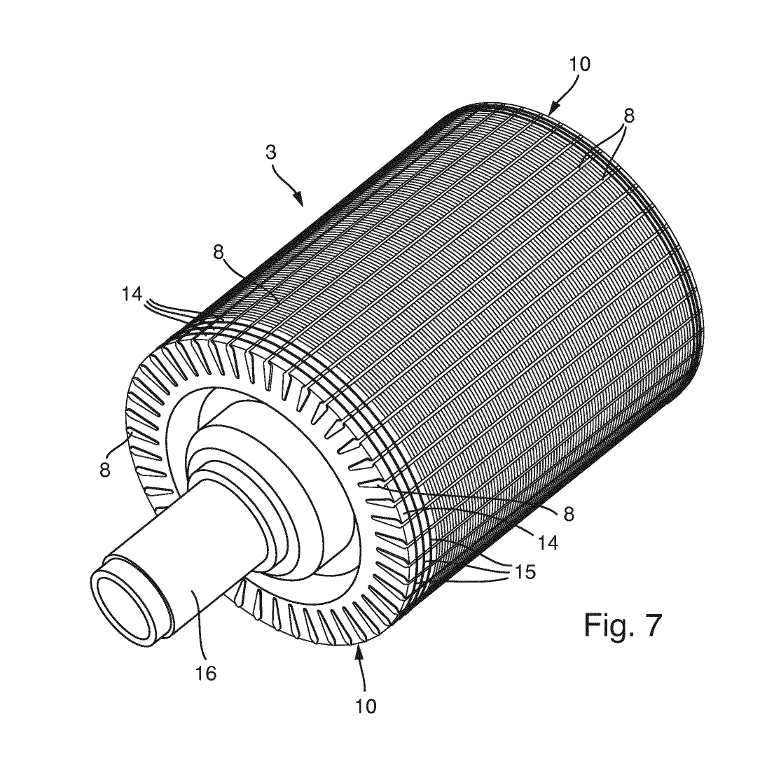

FIG. 7 shows a three-dimensional view of a fully mounted cage rotor 3 together with a shaft 16. In FIG. 7, the short-circuit bars 8 in the mounted state can also be seen along the laminated rotor core 2. This is because the rotor laminations 4 variant used here is one in which its radially outer end is open. In this embodiment, welding of the short-circuit bars 8 with the rotor core 2 could also be carried out by the provision of welded seams extending in the axial direction at the point of transition between the material of the conductor bars 8 and the material of the rotor core 2. For a planar outer contour of the cage rotor, the outer circumference of the cage rotor 3 would have to be machined down. Apart from this difference, reference is made to the above description.

To produce the inventive cage rotor 3, the laminated rotor core 2 described above is firstly provided. The short-circuit bars 8 are then inserted into the rotor lamination grooves 5, such that the short-circuit bars 8 project from both end faces 9 of the laminated rotor core 2. The short-circuit rings 10 are attached onto these projecting ends of the short-circuit bars 8, such that the short-circuit bars 8 project beyond the short-circuit rings 10 when the short-circuit rings 10 are fully attached. The short-circuit bars 8 are then connected, preferably welded or brazed, together with the short-circuit rings 10 on a side of the short-circuit ring grooves 11 that is open radially outwards. For purposes of balancing the cage rotor 3, material is preferably removed from selected balancing studs 13. Alternatively balancing weights, not shown, could be attached, for example welded, to the balancing studs 13.

In the accompanying drawings, for the sake of clarity, only one or a few of the rotor core grooves 5, the sections 7, the short-circuit bars 8, short-circuit ring grooves 11, the sections 12, and the balancing studs 13 are provided with a reference symbol.

### LIST OF REFERENCE SYMBOLS

1 Short-circuit cage
2 Laminated rotor core
3 Cage rotor
4 Rotor lamination
5 Rotor lamination groove
6 Shaft groove
7 Section
8 Short-circuit bar
9 End face of the laminated rotor core
10 Short-circuit ring
11 Short-circuit ring groove
12 Section
13 Balancing stud
14 Ring
15 Welded seam
16 Shaft

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof. The fact that certain features are cited in various dependent claims is not intended to imply that a combination of these features could not be used to advantage.

What is claimed is:

1. A cage rotor for an asynchronous machine, comprising:
a laminated rotor core including a plurality of stacked rotor laminations, which each have a plurality of circumferentially distributed rotor lamination grooves;
short-circuit rings, which are arranged on both end faces of the laminated rotor core, and which each have a plurality of short-circuit ring grooves distributed in a circumferential direction; and
short-circuit bars, which are inserted into the rotor lamination grooves, which extend through the short-circuit ring grooves and whose ends project beyond the short-circuit rings, wherein
the short-circuit ring grooves are at least partially open radially outwards, and
the short-circuit bars and the short-circuit rings are connected together on a side of the short-circuit ring grooves that is open radially outwards.

2. The cage rotor according to claim 1, wherein the short-circuit bars are welded or brazed together with the short-circuit rings on the side of the short-circuit ring grooves that is open radially outwards.

3. The cage rotor according to claim 1, wherein the short-circuit ring grooves have a section in which the short-circuit ring grooves taper radially outwards.

4. The cage rotor according to claim 2, wherein the short-circuit ring grooves have a section in which the short-circuit ring grooves taper radially outwards.

5. The cage rotor according to claim 1, wherein the short-circuit rings are constructed in each case from at least two rings stacked together.

6. The cage rotor according to claim 2, wherein the short-circuit rings are constructed in each case from at least two rings stacked together.

7. The cage rotor according to claim 1, wherein the short-circuit rings are forged, stamped out, chamfered, or cut out to their shape.

8. The cage rotor according to claim 6, wherein the short-circuit rings are forged, stamped out, chamfered, or cut out to their shape.

9. The cage rotor according to claim 5, wherein
a continuous or interrupted welded seam or brazed joint running in an encircling manner in the circumferential direction of the short-circuit rings runs on the side of the short-circuit rings facing radially outwards in each case between two adjacent rings, by way of which welded seam or brazed joint the short-circuit bars are also connected to the short-circuit rings.

10. The cage rotor according to claim 6, wherein
a continuous or interrupted welded seam or brazed joint running in an encircling manner in the circumferential direction of the short-circuit rings runs on the side of the short-circuit rings facing radially outwards in each case between two adjacent rings, by way of which welded seam or brazed joint the short-circuit bars are also connected to the short-circuit rings.

11. The cage rotor according to claim 1, wherein the short-circuit rings and/or short-circuit bars include aluminum.

12. The cage rotor according to claim 10, wherein the short-circuit rings and/or short-circuit bars include aluminum.

13. A method for producing a cage rotor, the method comprising the acts of:
providing a laminated rotor core from a plurality of stacked rotor laminations, which each have a plurality of circumferentially distributed rotor lamination grooves;
inserting short-circuit bars into the rotor lamination grooves, such that the short-circuit bars project from both end faces of the laminated rotor core;
attaching short-circuit rings onto the both end faces of the laminated rotor core, such that the short-circuit bars are inserted into short-circuit ring grooves and, in a fully attached state of the short-circuit rings, the short-circuit bars project beyond the short-circuit rings; and
connecting the short-circuit bars to the short-circuit rings on a side of the short-circuit ring grooves that is at least partially open radially outwards.

14. The method according to claim 13, wherein the act of connecting the short-circuit bars to the short-circuit rings further comprises the act of:
welding or brazing the short-circuit bars together with the short-circuit rings on a side of the short-circuit ring grooves that is open radially outwards.

15. The method according to claim 13, wherein the act of connecting the short-circuit bars to the short-circuit rings further comprises the act of:
connecting the short-circuit bars to the short-circuit rings on the side of the short-circuit ring grooves that is open radially outwards by way of a continuous or interrupted welded seam or brazed joint running in an encircling manner in the circumferential direction of the short-circuit rings.

16. The method according to claim 14, wherein the act of connecting the short-circuit bars to the short-circuit rings further comprises the act of:
connecting the short-circuit bars to the short-circuit rings on the side of the short-circuit ring grooves that is open radially outwards by way of a continuous or interrupted welded seam or brazed joint running in an encircling manner in the circumferential direction of the short-circuit rings.

17. The method according to claim 13, wherein the short-circuit rings are constructed in each case from at least two rings stacked together, the method further comprising the act of:
welding or brazing two adjacent rings in each case, on the side of the short-circuit rings facing radially outwards, by way of a continuous or interrupted welded seam or brazed joint running in an encircling manner in the circumferential direction of the short-circuit rings, with which the short-circuit bars are also connected to the short-circuit rings.

18. The method according to claim 14, wherein the short-circuit rings are constructed in each case from at least two rings stacked together, the method further comprising the act of:
welding or brazing two adjacent rings in each case, on the side of the short-circuit rings facing radially outwards, by way of a continuous or interrupted welded seam or brazed joint running in an encircling manner in the circumferential direction of the short-circuit rings, with which the short-circuit bars are also connected to the short-circuit rings.

19. The method according to claim 13, the method further comprising the act of:
balancing the cage rotor by removing material from selected short-circuit bars projecting beyond the short-circuit rings.

20. The method according to claim 18, the method further comprising the act of:
balancing the cage rotor by removing material from selected short-circuit bars projecting beyond the short-circuit rings.
